(19) United States
(12) Patent Application Publication
(10) Pub. No.: US 2008/0147498 A1
(43) Pub. Date: Jun. 19, 2008

(54) System and method for adjusting parameters of a digital ad and third-party traffic based on a difference in time between geographic regions

(75) Inventors: Ming-Hung Chao, Arcadia, CA (US); Raymond Hon, Monterey Park, CA (US)

Correspondence Address: BRINKS HOFER GILSON & LIONE / YAHOO! OVERTURE, P.O. BOX 10395, CHICAGO, IL, 60610, US

(73) Assignee: YAHOO! Inc.

(21) Appl. No.: 11/639,803

(22) Filed: Dec. 15, 2006

(51) Int. Cl. G06Q 30/00

(52) U.S. Cl. 705/14

(57) ABSTRACT

Systems and methods for adjusting parameters of a digital ad and third-party traffic based on a difference in time between geographic regions are disclosed. Generally, a monitoring module of an online advertisement service provider monitors performance information associated with a digital ad directed to potential customers in a first region associated with a first time zone to determine if the digital ad is performing well or performing poorly. Based on the monitored performance information associated with the digital ad directed to potential customers in the first region, at least one parameter associated with a digital ad directed to potential customers in a second region associated with a second, later time zone is adjusted to more effectively target the digital ads to potential customers in the second region.

### BACKGROUND

Advertisers advertising with online ad service providers such as Yahoo! Search Marketing often manage delivery of digital ads, such as graphical banner ads or sponsored search listings, by interacting with an ad campaign management system of the online ad service provider. Various examples of user interfaces and application program interfaces for displaying and managing information related to digital ads are disclosed in U.S. patent application Ser. No. 11/413,514, filed Apr. 28, 2006, and assigned to Yahoo! Inc.

Advertisers or campaign optimizers of the ad campaign management system set parameters such as bids or business objectives to affect the placement of digital ads in webpages or search results viewed by potential customers. Typically, advertisers or campaign optimizers set the parameters based on historical data collected by the ad campaign management system showing patterns in the behavior of potential customers during similar periods of time, such as the behavior of potential customers during a previous day, week, month, or even year. As online advertising has become more popular, advertisers desire information regarding the real-time behavior of potential customers so that advertisers or campaign optimizers of the ad campaign management system may quickly alter parameters such as bids or business objectives to better target digital ads to the current exhibited interests of potential customers rather than to the historical behavior of potential customers.

### BRIEF DESCRIPTION OF THE DRAWINGS

FIG. 1 is a block diagram of one embodiment of an environment in which a system for adjusting parameters of a digital ad and third-party traffic based on a difference in time between geographic regions may operate;

FIG. 2 is a diagram of a number of click throughs (“clicks”) in the Eastern time zone vs. Eastern time, and a number of clicks in the Pacific time zone vs. Eastern time;

FIG. 3 is a block diagram of one embodiment of a system for adjusting parameters of a digital ad and third-party traffic based on a difference in time between geographic regions;

FIG. 4 is a flow chart of one embodiment of a method for adjusting parameters of a digital ad based on a difference in time between geographic regions; and

FIG. 5 is a flow chart of one embodiment of a method for adjusting levels of traffic from a third party traffic provider based on a difference in time between geographic regions.

### DETAILED DESCRIPTION OF THE DRAWINGS

The present disclosure is directed to systems and methods for adjusting parameters of a digital ad and third-party traffic based on a difference in time between geographic regions. Adjusting parameters of a digital ad based on a difference in time between geographic regions, such as time zones, provides online ad service providers (“ad providers”) and advertisers the ability to quickly adjust parameters which affect how and where the digital ads of an advertiser are served to more effectively target digital ads to potential customers. Generally, potential customer behavior and traffic patterns related to digital ads directed to potential customers in a first region associated with a first time zone are monitored during a time period. Based on the monitored potential customer behavior and traffic patterns, an ad provider and advertisers may more effectively target their digital ads to potential customers in a second region associated with a second time zone during the same time period. For example, an ad provider or advertiser may adjust a bid or position of a digital ad directed to potential customers during a time period in the Central time zone, such as 1:00 p.m.-2:00 p.m. CST, based on monitored potential customer behavior or traffic patterns related to digital ads directed to potential customers during the same time period in the Eastern time zone, such as 1:00 p.m.-2:00 p.m. EST. Similarly, an ad provider may determine whether to limit traffic from a third party traffic provider to potential customers during a time period in the Central time zone based on the quality of traffic delivered during the same time period to potential customers in the Eastern time zone. Using monitored potential customer behavior in a first time zone to better target digital ads directed to potential customers in a second time zone provides the ability for advertisers and ad providers to better target digital ads to potential customers in the second time zone when the amount of time for processing information related to digital ads prevents an ad provider from providing real-time information regarding the performance of digital ads.

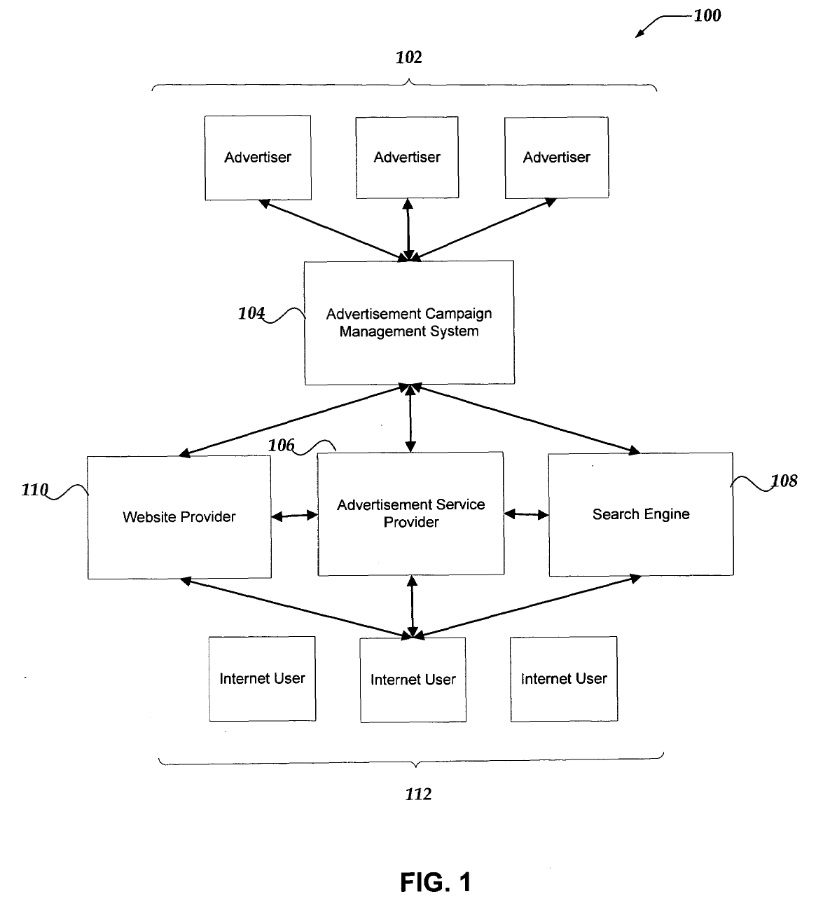

FIG. 1 is a block diagram of one embodiment of an environment in which a system for adjusting parameters of a digital ad and third-party traffic based on a difference in time between geographic regions may operate. However, it should be appreciated that the systems and methods described below is not limited to use with a search engine or pay-for-placement online advertising. The environment 100 includes a plurality of advertisers 102, an ad campaign management system 104, an ad provider 106, a search engine 108, a website provider 110, and a plurality of Internet users 112. Generally, an advertiser 102 bids on terms and creates one or more digital ads by interacting with the ad campaign management system 104 in communication with the ad provider 106. The digital ad may be a graphical banner ad that appears on a website viewed by Internet users 112, a sponsored search listing that is served to an Internet user 108 in response to a search performed at a search engine, a video ad, a graphical banner ad based on a sponsored search listing, and/or any other type of online marketing media known in the art.

When an Internet user 112 performs a search at a search engine 108, or views a website served by the website provider 110, the ad provider 106 serves one or more digital ads created using the ad campaign management system 104 to the Internet user 112 based on search terms or keywords provided by the Internet user 112 or obtained from a website. Additionally, the ad campaign management system 104 and ad provider 106 typically record and process information associated with the served digital ads for purposes such as reporting or ad campaign optimization. For example, the ad campaign management system 104 and ad provider 106 may record the search terms that caused the ad provider 106 to serve the digital ads; whether the Internet user 112 clicked on a URL associated with the served digital ads; what additional digital ads the ad provider 106 served with the digital ad; a rank or position of a digital ad when the Internet user 112 clicked on the digital ad; or whether an Internet user 112 clicked on a URL associated with a different digital ad. One example of an ad campaign management system the may perform these types of actions is disclosed in U.S. patent application Ser. No. 11/413,514, filed Apr. 28, 2006 and assigned to Yahoo! Inc.

It will be appreciated to those skilled in the art that the disclosed systems and methods for adjusting parameters of a digital ad and third-party traffic based on a difference in time between geographic regions may operate in the environment of FIG. 1.

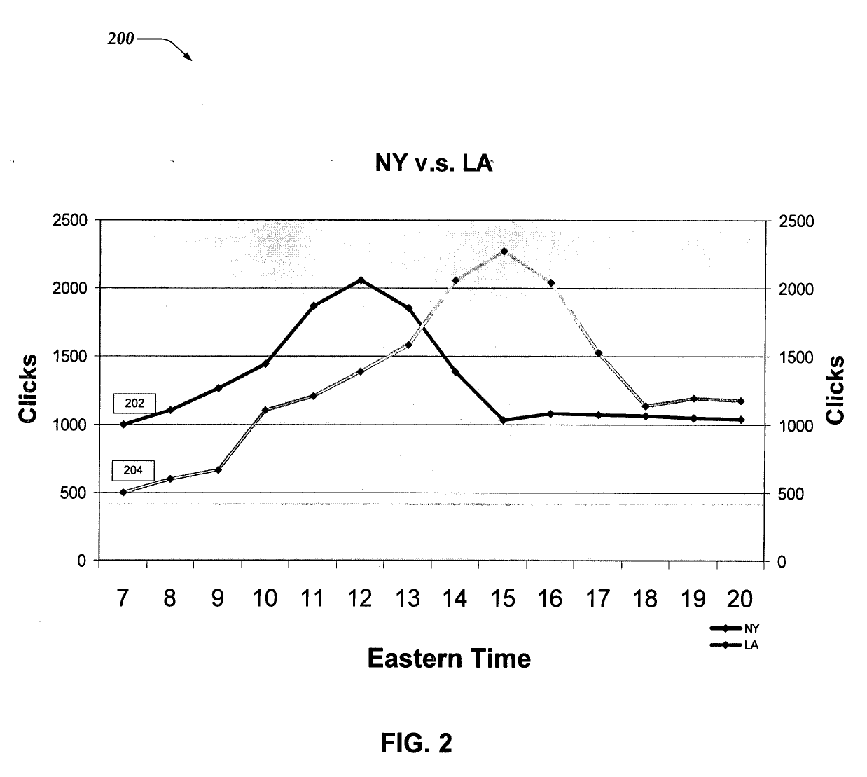

FIG. 2 is a diagram illustrating a number of click throughs (“clicks”) on digital ads served to potential customers in a city located in the Eastern time zone vs. Eastern time 202, and a number of clicks on digital ads served to potential customers in a city located in the Pacific time zone vs. Eastern time 204. As shown in FIG. 2, the pattern of potential customers in the city located in the Eastern time zone 202 is similar to the pattern of potential customers in the city located in the Pacific time zone 204, but offset by three hours corresponding to the difference in time between the Eastern time zone and the Pacific time zone. In other words, potential customers exhibit similar patterns during the same local time periods such that potential customers in the first city in the Eastern time zone behave similarly at 1:00 p.m. EST to potential customers in the second city in the Pacific time zone at 1:00 p.m. PST.

Advertisers and ad campaign optimizers may associate cities and regions in different time zones that historically demonstrate similar behavior to more effectively target digital ads during a period of time in a later time zone based on observed potential customer behavior during the same period of time in an earlier time zone. For example, if an advertiser determines that digital ads related to a specific product are producing a higher than normal click-through rate, or that digital ads located at a particular position in a webpage are producing a higher than normal click-through rate for digital ads served to potential customers located in the Eastern time zone at 1:00 p.m. EST, the advertiser or ad campaign optimizer may desire to have more digital ads served related to the specific product, or have more digital ads placed at or near the particular position in a webpage served to potential customers located in the Central time zone at 1:00 p.m. CST, potential customers located in the Mountain time zone at 1:00 p.m. MST, and potential customers located in the Pacific time zone at 1:00 p.m. PST. Various systems and methods for directing digital ads to specific regions such as specific time zones, zip codes, or cities are disclosed in U.S. patent application Ser. No. 11/314,191, filed Dec. 13, 2005, and assigned to Yahoo! Inc.

While the above-described principle has been described with respect to time zones located within the United States, the same principle may be applied across time zones in other parts of the world. For example, patterns of potential customers in a first time zone in Eastern Europe may be used to more effectively target digital ads directed to potential customers in a second time zone in Western Europe, or patterns of potential customers in a first time zone in Europe may be used to more effectively target digital ads directed to potential customers in a second time zone in the United States, Canada, or countries in South America. Similarly, while the above-described principle has been described with respect to time zones, the same principle may be applied to cities in different time zones or across regions of the world spanning multiple time zones. For example, advertisers may monitor behavior of potential customers in the eastern half of the United States as a whole, including the Eastern and Central time zones, to better target digital ads directed to potential customers in the western half of the United States as a whole, including the Mountain and Pacific time zones.

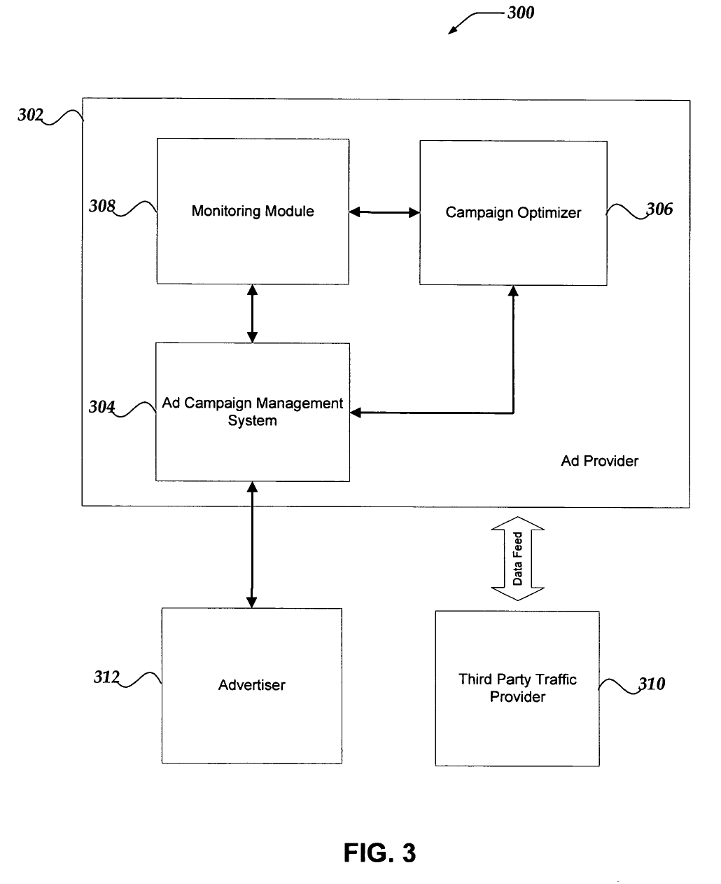

FIG. 3 is a block diagram of one embodiment of a system for adjusting parameters of a digital ad and third-party traffic based on a difference of time between geographic regions. The system 300 may include an ad provider 302 that includes an ad campaign management system 304, a campaign optimizer 306 and a monitoring module 308. Additionally, the system 300 may include one or more third party traffic providers 310 that provide digital ads from the ad provider 302 to potential customers viewing webpages not associated with the ad provider 302, and the system 300 may include one or more advertiser systems 312 that interact with the ad campaign management system 304 of the ad provider 302. Typically, the advertiser systems 312 communicate with the ad campaign management system 304 over one or more external networks such as the Internet, and the ad provider 302, ad campaign management system 304, ad campaign optimizer 306, monitoring module 308 and third party traffic providers 310 communicate with one another over one or more external or internal networks. The ad provider 302, ad campaign management system 304, ad campaign optimizer 306, monitoring module 308, third party traffic providers 310, and advertiser systems 312 may be implemented as software code stored on a computer-readable medium and running in conjunction with a processor such as a personal computer, a single server, a plurality of servers, or any other type of computing device known in the art.

Advertisers using advertiser systems 312 to interact with the ad campaign management system 304 may create one or more digital ads such as graphical banner ads or sponsored search listings to be served to a potential customer in response to actions such as performing a search at a search engine or requesting a webpage. As part of creating the digital ads, an advertiser may set parameters such as a bid amount, ad position, or business objective associated with the digital ads. A bid amount is an amount of money that an advertiser agrees to compensate the ad provider 302 upon the occurrence of a specified action, such as when a graphical ad is served or a user clicks on a sponsored search listing, depending on the type of digital ad served. Ad positions and business objectives are typically settings provided to the campaign optimizer 306 based on an advertising strategy of an advertiser. The campaign optimizer 306 automatically adjusts a bid associated with one or more digital ads in accordance with the desired position and business objectives of the advertiser to implement the advertising strategy of the advertiser. One example of an ad campaign optimizer 206 is disclosed in U.S. patent application Ser. No. 11/321,729, filed Dec. 28, 2005, and assigned to Yahoo! Inc.

The monitoring module 308 of the ad provider 302 monitors performance information such as ad campaign information associated with one or more digital ads directed to users in a geographic region that is associated with one or more time zones. Ad campaign information may include information such as current and/or historical performance of a digital ad or one or more groupings of digital ads; campaign objectives relating to a digital ad or one or more groupings of digital ads; budget-related conditions or constraints relating to a digital ad or one or more groupings of digital ads; information specifying, defining, or describing a digital ad or one or more groupings of digital ads; bidding parameters such as maximum or minimum bidding positions associated with a digital ad or one or more groupings of digital ads; metrics such as return on ad spend (“ROAS”), cost per click (“CPC”), or clicks per impression (“CPI”) associated with a digital ad or one or more groupings of digital ads; cost per acquisition (“CPA”); or any other parameter associated with a digital ad or one or more groupings of digital ads provided by an ad provider 302.

The monitoring module 308 monitors performance information such as ad campaign information associated with one or more digital ads directed to potential customers in a geographic region associated with a first time zone to determine whether performance information such as various performance parameters exceed or fall below one or more thresholds indicative of a digital ad that is performing well or indicative of a digital ad that is performing poorly. For example, if the monitoring module 308 determines that a return on ad spend (“ROAS”) or clicks per impression (“CPI”) related to one or more digital ads exceeds a threshold during a time period, the monitoring module 308 determines that the one or more digital ads are performing well during the time period. However, if the ROAS or CPI related to one or more digital ads falls below another threshold during a time period, the monitoring module 308 determines that the one or more digital ads are performing poorly during the time period.

Similarly, if the monitoring module 306 determines that a cost per acquisition (“CPA”) related to one or more digital ads falls below a threshold during a time period, the monitoring module 308 determines that the one or more digital ads are performing well during the time period. However, if the monitoring module 308 determines that a CPA related to one or more digital ads exceeds another threshold during a time period, the monitoring module 308 determines that the one or more digital ads are performing poorly during the time period.

Periodically, or in real-time, the monitoring module 308 may communicate to systems of the ad provider 302 such as the ad campaign management system 304 and/or the campaign optimizer 306 which digital ads or grouping of digitals ads directed to potential customers in a first region associated with a first time zone are performing well or performing poorly for the purpose of notification. Based on the received communications, systems of the ad provider 302 such as the ad campaign management system 304 and/or the campaign optimizer 306 may send notifications to advertisers 312 indicating which digital ads or grouping of digitals ads are performing well, or performing poorly, in the first region so that advertisers 312 may more effectively target their digital ads by modifying bids or business objectives associated with similar digital ads directed to potential customers in a second region associated with a second, later time zone.

The notices may include information regarding how related keywords or bidded phrases are performing during a time period in the first region; what positions in webpages or sponsored search listings are performing well during a time period in the first region; suggestions for bids or business objectives for digital ads directed to potential customers in the second region; or any other type of information related to the monitored information that may be helpful to advertisers with digital ads directed to potential customers in the second region. One example of a system for reporting information to advertiser systems 312 is disclosed in U.S. patent application Ser. No. 11/413,699, filed Apr. 28, 2006, assigned to Yahoo! Inc.

Alternatively or in addition, the monitoring module 308 may communicate to systems of the ad provider 302 such as the ad campaign management system 304 and/or the ad campaign optimizer 306 which digital ads or grouping of digital ads directed to potential customers in a first region associated with a first time zone are performing well or performing poorly for the purpose of automatic campaign optimization. Based on the received communications, systems of the ad provider 302 such as the ad campaign management system 304 and/or the ad campaign optimizer 306 may automatically adjust bids, keyword, bidded phrases, or business objectives associated with digital ads; a level of traffic from a third-party traffic provider (as discussed in more detail below); or any other parameter associated with a digital ad or grouping of digital ads that are directed to potential customers in a second region associated with a second, later time zone to implement an advertising strategy set by an advertiser. The campaign optimizer 306 may adjust parameters associated with a digital ad or groupings of digital ads at a digital ad level, keyword level, ad group level, or ad campaign level.

Ad groups provide advertisers the ability to define their own groups of ad campaign information (known as an ad group) for digital ads that will be handled by the ad campaign management system 304 in a similar manner. For example, advertisers may group digital ads by search tactic, performance parameter, user demographic, family of products, or almost any other parameter desired by the advertiser. Allowing advertisers to define their own ad groups allows the ad campaign management system 304 to provide more useful information to the advertiser, thereby allowing the advertiser to display, manage, optimize, or view reports on advertisement campaign information in a manner most relevant to an individual advertiser. Various examples of user interfaces and application program interfaces for displaying, managing, optimizing, and viewing reports on ad campaign information by ad groups are disclosed in U.S. patent application Ser. No. 11/413,514, filed Apr. 28, 2006, assigned to Yahoo! Inc.

In addition to monitoring performance information associated with one or more digital ads in general, the monitoring module 308 may also monitor performance information associated with one or more digital ads with respect to traffic from a third-party traffic provider to determine the quality of traffic provided by the third party traffic provider 310. For example, the monitoring module 308 may monitor whether traffic provided by a third party traffic provider 310 drives a return on ad spend (“ROAS”) or clicks per impression (“CPI”) down, or a cost upper acquisition (“CPA”) up, related to one or more digital ads while traffic from other traffic providers are not having similar effects on the same digital ads. When this happens, the monitoring module 308 may notify systems of the ad provider 302 such as the ad campaign management system 304 and/or the campaign optimizer 306 that the third party traffic provider 310 is providing unfavorable traffic during a time period to potential customers in a first region associated with a first time zone. In response, systems of the ad provider 302 may restrict traffic from the third party traffic provider 310 for similar digital ads directed to potential customers in a second region associated with a second, later time zone so that the traffic from the third party traffic provider 310 does not adversely affect similar digital ads directed to potential customers in the second region.

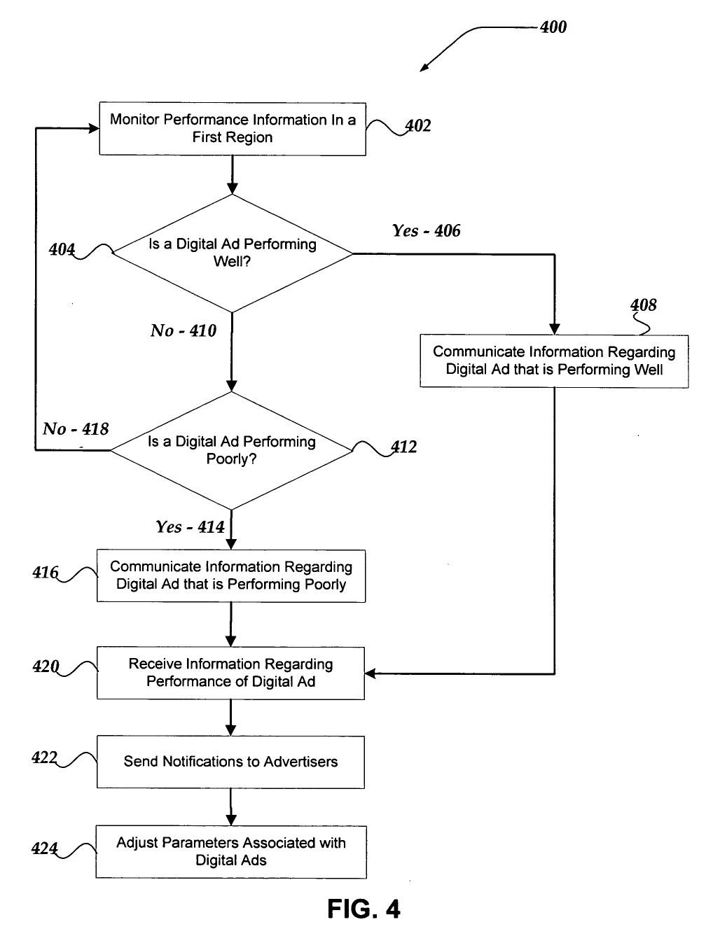

FIG. 4 is a flow chart of one embodiment of a method for adjusting parameters associated with a digital ad based on a difference in time between geographic regions. The method begins with a monitoring module of an ad provider monitoring performance information, such as ad campaign information, associated with a digital ad directed to potential customers in a first region associated with a first time zone at step 402. As discussed above, the first region may be a city, an entire time zone, a portion of a single time zone, or portions of multiple time zones.

Periodically, or in real-time, the monitoring module determines whether a digital ad or a grouping of digital ads directed to potential customers in the first region are performing well at step 404. As described above, the monitoring module may determine that a digital ad or grouping of digital ads is performing well by monitoring whether performance information associated with a digital ad exceeds a threshold, or falls below another threshold, indicative of a digital ad performing well. If the monitoring module determines a digital ad or grouping of digital ads is performing well (406), the monitoring module communicates information relating to the digital ad, grouping of digital ads, or specific ad campaign information performing well to systems of an ad provider such as an ad campaign management system and/or a campaign optimizer at step 408. If the monitoring module does not determine that the digital ad or grouping of digital ads is performing well (410), the method continues.

Periodically, or in real-time, the monitoring module determines whether a digital ad or a grouping of digital ads directed to potential customers in the first region are performing poorly at step 412. The monitoring module may determine that a digital ad or grouping of digital ads is performing poorly by monitoring whether performance information associated with a digital ad exceeds a threshold, or falls below another threshold, indicative of a digital ad performing poorly. If the monitoring module determines a digital ad or grouping of digital ads is performing poorly (414), the monitoring module communicates information relating to the digital ads, grouping of digital ads, or specific ad campaign information performing poorly to systems of the ad provider such as the ad campaign management system and/or the campaign optimizer at step 416. If the monitoring module determines a digital ad or grouping of digital ads is not performing poorly (418), the method returns to step 402 and the monitoring module continues to monitor ad campaign information associated with digital ads directed to potential customers in a first region

At step 420, the ad campaign management system or the campaign optimizer receives information from the monitoring module representing digital ads, grouping of digital ads, or specific campaign information related to digital ads directed to potential customers in the first region that are performing poorly or well during the given time period. Based on the received information, systems of the ad provider such as the ad campaign management system and/or the campaign optimizer may send notifications to advertisers regarding the received information at step 422. As described above, the notices may include information such as related keywords or bidded phrases that are performing well or poorly during the time period; positions in webpages or sponsored search listings that are performing well or poorly during a time period; suggestions for bids or business objectives for digital ads directed to potential customers in earlier time regions; or any other type of information related to the monitored information that may be helpful to advertisers with digital ads directed to potential customers in a second region associated with a second, later time zone. Based on the notices, advertisers may access the ad campaign management system and change one or more parameters associated with digital ads or groupings of digital ads directed to potential customers in the second region.

In addition or as an alternative to sending the notifications, at step 424 systems of the ad provider such as the ad campaign management system and/or the campaign optimizer may change one or more parameters associated with digital ads directed to potential customers in the second region based on the information received at step 420. As described above, systems of the ad provider such as the ad campaign management system and/or the campaign optimizer may automatically adjust bids, keywords, bidded phrases, or business objectives associated with digital ads; levels of traffic from third-party traffic providers; or any other parameter associated with a digital ad or grouping of digital ads to implement an advertising strategy set by an advertiser.

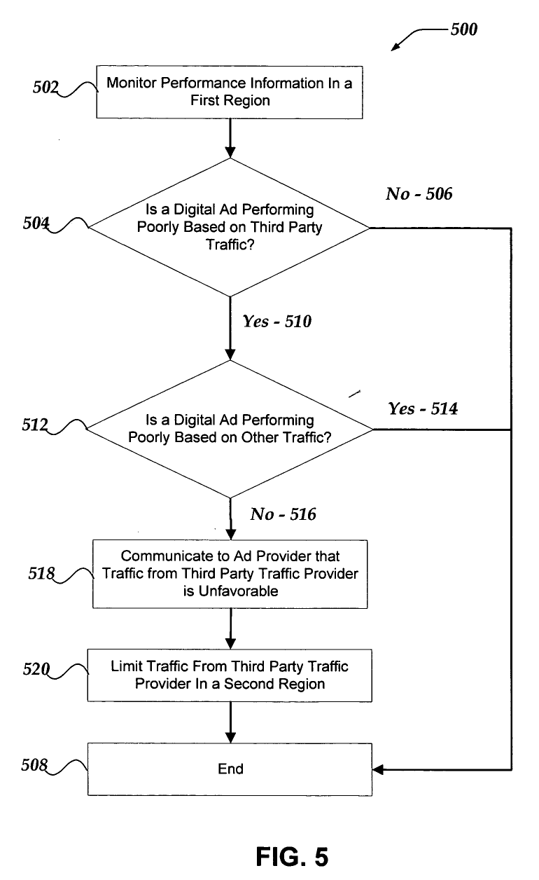

FIG. 5 is a flow chart of one embodiment of a method for adjusting traffic flow from a third party traffic provider based on a difference in time between geographic regions. The method begins with a monitoring module monitoring performance information associated with one or more digital ads directed to potential customers in a first region, associated with a first time zone, based on traffic from a third party traffic provider at step 502.

The monitoring module monitors performance information associated with one or more digital ads to determine if performance information associated digital ads with respect to with traffic from a third party traffic provider exceed a threshold, or fall below another threshold, indicative of a digital ad performing poorly at step 504. If the monitoring module does not determine that a digital ad or grouping of digital ads is performing poorly with respect to traffic from the third party traffic provider (506), the monitoring module does not perform any actions with respect to the third party traffic provider and the method ends at step 508.

However, if the monitoring module determines that a digital ad or grouping of digital ads is performing poorly with respect to traffic from the third party traffic provider (510), the monitoring module determines if the digital ad or grouping of digital ads is performing poorly with respect to traffic from other traffic providers, such as traffic from the ad provider or other third-party traffic providers, at step 512. If the monitoring module determines that the digital ad or grouping of digital ads is performing poorly with respect to traffic from other traffic providers (514), the monitoring module does not perform any actions with respect to the third party traffic provider and the method ends at step 508. However, if the monitoring module determines that the digital ad or grouping of digital ads is not performing poorly with respect to traffic from other traffic providers (516), the monitoring module communicates to systems of the ad provider such as the ad campaign management system and/or campaign optimizer that the third party traffic provider is providing low quality traffic at step 518. In response to the communication, the ad provider restricts traffic from the third party traffic provider related to a digital ad or groupings of digital ads directed to users in a second region, associated with a second, later time zone, at step 520, and the method ends at step 508.

FIGS. 1-5 describe systems and methods for adjusting parameters of a digital ad and third-party traffic based on a difference in time between geographic regions. Adjusting parameters of a digital ad based on a difference in time between geographic regions provides ad providers and advertisers the ability to better target digital ads to potential customers in a second region associated with a second time zone based on monitored behavior of potential customers in a first region associated with a first, earlier time zone. Due to the relationships between time zones, ad providers and advertisers are able to more effectively target the delivery of digital ads to potential customers based on current exhibited interests of potential customers.

Further, providing the ability to adjust traffic to potential customers in a second region associated with a second time zone during a period of time, based on monitored behavior of potential customers or quality of traffic from third-party traffic providers in a first region associated with a first, earlier time zone during the same period of time, allows the ad provider to increase the quality of traffic for served digital ads.

It is therefore intended that the foregoing detailed description be regarded as illustrative rather than limiting, and that it be understood that it is the following claims, including all equivalents, that are intended to define the spirit and scope of this invention.

1. A method for adjusting a parameter associated with a digital ad, the method comprising:
monitoring performance information associated with a digital ad directed to potential customers in a first region associated a first time zone; and
adjusting at least one parameter associated with a digital ad directed to potential customers in a second region associated with a second, later time zone based on the monitored performance information associated with the digital ad directed to potential customers in the first region.

2. The method of claim 1, wherein the first and second regions are time zones.

3. The method of claim 1, wherein at least a portion of the first and second regions are located in the same country.

4. The method of claim 1, wherein the first and second regions are located in different countries.

5. The method of claim 1, wherein the first and second regions are cities.

6. The method of claim 1, wherein monitoring performance information associated with a digital ad directed to potential customers in a first region comprises:
determining whether performance information associated with a digital ad exceeds a threshold indicative of a digital ad performing well.

7. The method of claim 1, wherein monitoring performance information associated with a digital ad directed to potential customers in a first region comprises:
determining whether performance information associated with a digital ad falls below a threshold indicative of a digital ad performing poorly.

8. The method of claim 1, wherein monitoring performance information associated with a digital ad directed to potential customers in a first region comprises:
determining whether performance information associated with a digital ad falls below a threshold indicative of a digital ad performing well.

9. The method of claim 1, wherein monitoring performance information associated with a digital ad directed to potential customers in a first region comprises:
determining whether performance information associated with a digital ad exceeds a threshold indicative of a digital ad performing poorly.

10. The method of claim 1, further comprising:
sending a notification to an advertiser with a digital ad directed to potential customers in the second region based on the monitored performance information associated with the digital ad directed to potential customers in the first region.

11. The method of claim 1, wherein adjusting at least one parameter associated with a digital ad comprises:
changing a bid associated with the digital ad.

12. The method of claim 1, wherein adjusting at least one parameter associated with a digital ad comprises:
changing an ad position associated with the digital ad.

13. The method of claim 1, wherein:
monitoring performance information associated with a digital ad directed to potential customers in a first region comprises monitoring performance information associated with the digital ad directed to potential customers in the first region with respect to traffic from a third party traffic provider; and
adjusting at least one parameter associated with a digital ad comprises adjusting a level of traffic from the third party traffic provider with respect to a digital ad directed to potential customers in a second region based on the monitored performance information associated with the digital ad directed to potential customers in the first region with respect to traffic from the third party traffic provider.

14. A system for adjusting a parameter associated with a digital ad, the system comprising:
a monitoring module operative to monitor performance information associated with a digital ad directed to potential customers in a first region associated with a first time zone; and
an online advertisement service provider operative to receive information from the monitoring module regarding performance information associated with the digital ad directed to potential customers in the first region and to adjust at least one parameter associated with a digital ad directed to potential customers in a second region associated with a second, later time zone based on the received information.

15. The system of claim 14, wherein the first and second regions are time zones.

16. The system of claim 14, wherein the first and second regions are cities.

17. The system of claim 14, wherein the monitoring module is operative to determine whether performance information associated with the digital ad exceeds a threshold indicative of a digital ad performing well.

18. The system of claim 14, wherein the monitoring module is operative to determine whether performance information associated with the digital ad falls below a threshold indicative of a digital ad performing poorly.

19. The system of claim 14, wherein the monitoring module is operative to determine whether performance information associated with the digital ad falls below a threshold indicative of a digital ad performing well.

20. The system of claim 14, wherein the monitoring module is operative to determine whether performance information associated with the digital ad exceeds a threshold indicative of the digital ad performing poorly.

21. The system of claim 14, wherein the monitoring module is operative to monitor performance information associated with the digital ad directed to potential customers in the first region with respect to traffic from a third party traffic provider and wherein the online advertisement service provider is operative to adjust a level of traffic from the third party traffic provider with respect to the digital ad directed to potential customers in the second region based on the monitored performance information associated with the digital ad directed to potential customers in the first region with respect to traffic from the third party traffic provider.

22. The system of claim 14, wherein the online advertisement service provider is operative to notify an advertiser with a digital ad directed to potential customers in the second region regarding the monitored performance information associated with the digital ad directed to potential customers in the first region.

23. A computer-readable storage medium comprising a set of instructions for adjusting at least one parameter associated with a digital ad, the set of instructions to direct a processor to perform the acts of:
monitoring performance information associated with a digital ad directed to potential customers in a first region associated a first time zone; and
adjusting at least one parameter associated with a digital ad directed to potential customers in a second region associated with a second, later time zone based on the monitored performance information associated with the digital ad directed to potential customers in the first region.

24. The computer-readable storage medium of claim 21, wherein the first and second regions are time zones.

25. The computer-readable storage medium of claim 21, wherein the first and second regions are cities.
